(19) United States
(12) Patent Application Publication
(10) Pub. No.: US 2009/0136745 A1
(43) Pub. Date: May 28, 2009

(54) Method for Producing a Device for Displaying the Effect of the invironment on environmentally-dependent materials

(76) Inventors: Julius A. Nickl, Zorneding (DE); Georg Walter, Lupburg (DE)

Correspondence Address: Horst M. Kasper, 13 Forest Drive, Warren, NJ, 07059, US

(21) Appl. No.: 11/885,825

(22) PCT Filed: Mar. 3, 2006
(86) PCT No.: PCT/DE06/00381

§ 371 Date: Jun. 16, 2008

(30) Foreign Application Priority Data
Mar. 3, 2005 (DE) 10 2005 010 224.7
Jan. 13, 2006 (DE) 10 2005 001 865.6

(51) Int. Cl. B32B 17/10; B05D 1/36

(52) U.S. Cl. 428/339; 427/419.1

(57) ABSTRACT

The invention relates to a method for producing a device (1) for displaying the effect of the environment (2) on environmentally dependent materials, especially mixtures (4) with invariably visual properties according to the time and the environment (2). The invention illustrates how the mixtures (4) or the materials thereof are treated with different constituent concentrations (C) at different points on a matrix (5). The material produced enables a time-controlled simple display for controlling the usability of a product in accordance with requirements. The inventive device (1) enables visually perceptible characteristics of the mixture (4) to be modified by outside influences according to the time.

The present invention concerns a method for the production of a device for displaying the action of the environment onto environmentally dependent materials, in particular the provision of material mixtures, which change their visual properties depending on time and environment and their materials, which have different component concentrations at different locations.

For example, a toothbrush with a use display is disclosed in U.S. Pat. No. 4,802,255, wherein a coloring agent contained in the toothbrush filaments slowly escapes by the effect during the brushing of the teeth with increasing use in compounds or compositions. This color change gives a visual indication to the user data toothbrush should be replaced by a new one. In distinction to the present Invention there is required an immediate action of the user of the toothbrush in order to obtain a color change. In addition the coloring agent escapes out of the filaments of the tooth brush and comes into contact with the user of the toothbrush through the mucous membranes in the mouth, wherein health risks cannot be excluded. Such a color change occurs according to the present invention only based on external influences such as for example humidity or heat, and there is not required any direct action of the user for such a change and the user does not come into immediate contact with the compounds or compositions, whereby health risks are completely excluded.

A display device for time dependent processes is disclosed in printed patent document WO 2005/010624 A2. This display device comprises a chamber containing a liquid and a porous indicator strip, wherein the porous indicator strip is furnished at one position with a coloring agent dissolving in the liquid, wherein the coloring agent after dissolution in the liquid colors the indicator strip over its length depending on time. This construction shows the course of time over a migrating sharp coloring front. A relatively complex construction of a chamber containing a liquid, of a porous indicator strip and of a coloring agent reservoir is required with that invention.

Methods and devices are known for the more from the U.S. Pat. No. 6,318,128 B1 and the printed patent document WO 97/09278, wherein components of the material are successively united and leave the device as a certain complete product. In addition, a method is known from the Japanese printed patent documents JP 2003226582 A and JP 06145709 A for production of thin ceramic film layers on a silicon basis, which filling layers exhibit a gradient of the component concentrations of certain particles cross to the surface.

Furthermore methods and devices are known in the state of the art, wherein the components of the material are united successively and are then mixed. A mixture of individual components is employed in the different way and individual ones of the components are turned over whereby a new composition of the material is produced from new components. Also more complex methods for production of compositions are employed. One kind is for example the production of a mixture of desired components by using of a solvent such as water in order to allow for a better mixing of the components, wherein following thereto the water is evaporated and the residual components furnish the desired composition.

Similar methods were employed in the production of compositions in the area of plastic materials. For example plastics such as polyvinyl chloride PVC are mixed with coloring agents and softeners to produce compositions which can be employed for toys, household apparatus, floor coverings, containers, safety locks, safety cards, money documents, machine components and so on (compare for example German petit patent Gebrauchsmuster DE 29919849 and the German patent application DE 10141250). Problems appear then when materials are desired, which are to exhibit a gradient of a certain component in one direction. This is for example then desired when a softener or coloring agent of a toy or floor for example can be leached by the saliva of a child and then health dangers cannot be excluded for the child. It would be advantageous here, if the coloring agent and/or softener would be present only at locations, where a contact with a licking child would not be possible. A plastic with the gradient of these materials would be for example a solution to this problem. A pure mixture of the components or a mixture with the liquid thinning agent, such as for example an organic solvent, however cannot be helpful here. Therefore layer structures are employed as a so-called emergency solution technologically, wherein the different components are laminated on top of each other in layers such that the components are present in the upper layers, which are to exhibit a low concentration or concentration of 0 percent of the certain component (for example softener and/or coloring agent), and wherein in lower layers the components are present, which are to exhibit a higher concentration or a concentration of up to 100 percent of the certain component (compare for example the German patents DE 2911838 and DE 10023862).

A similar problem occurs in connection with the realization of the practical installation of devices for displaying of certain time dependent processes. Thus there are described layer structures in the state of the art, through which a time dependent influencing of for example oxygen onto an indicator sensitive to oxygen is realized (compare for example printed patent document WO 99/30148, German printed patent document DE 19830572, U.S. Pat. No. 5,630,371 and Japanese printed patent document JP-A-60071955). Here a layer of an indicator composition sensitive to oxygen is covered with a layer of oxygen catching material. Based on the kind and the thickness of the material catching the oxygen, the diffusion of oxygen through the layer of material catching oxygen can be controlled and therewith a time dependent color change of the indicator sensitive to oxygen can be accomplished. Here again this is associated with a very high expenditure since layer structures have to be constructed, which entail several work steps during the production of such devices and here again a method for production of a desired material would help, wherein the composition exhibits a gradient of a certain component of the composition (here the oxygen sensitive indicator) in the desired composition. It is to be noted here that the concept ‘gradient’ does not refer to a linear gradient, but is only intended to express that different concentrations of the certain component are present at different locations of the composition.

It is usual at the present time that foods, cosmetics, medications and the like are furnished with service life data in printed form. These data relating to service life however usually referred to only the materials, which are present in their un-opened packages. As soon as the package of the materials is opened, then the imprinted service life data is not any longer valid and the service life of the respective material can be reduced for example from several years in the closed package to a few days in the opened package.

In order to have an approximate indication for the service life of the material with opened packaging, there exists a need for devices for displaying of approximate service life.

Since all the above recited methods and devices cause a relatively high technical expenditure and therewith connected high costs, it is an object of the present Invention to furnish a method for production of a device of a certain suitable material, where the device visually indicates to the consumer without auxiliary means after the opening of the packaging, in which use state the product is present in the packaging.

This object is obtained with the characterizing features of the main claims.

According to the present Invention the method for production of a device for displaying the interaction of the environment on environmentally dependent materials is characterized by the following process steps:

furnishing a suitable material mixture with the addition of at least one component, which component changes its visually perceivable features, such as for example the color, under the interaction of external influences of the environment;

enveloping of the suitable material mixture in the matrix with a high diffusion resistance (coefficient) for predetermined gases, for example oxygen;

enveloping of the material mixture and the first layer in the gas impermeable outer envelope.

A container only permeable for outer influences, closed, either transparent or permeable for gaseous materials is employed with the present invention, wherein compounds or compositions are present in the container, where the compounds or compositions change by outer influences, or the compounds or compositions are formulated immediately in such a way, which enables a time dependent influencing through the outer influences on the compounds or compositions, wherein the change is perceivable by the senses of the user.

It is advantageous for the present invention that a chemical luminescence indicator is employed for the material mixture.

It is furthermore advantageous that a TiCl₃ is employed for the material mixture.

It is also advantageous that at least one acid indicator is employed for the material mixture.

It is furthermore advantageous that a metanil yellow or litmus or acid fuchsine is employed as an acid indicator.

It is furthermore advantageous that phenolphtalein is employed as an acid indicator.

It is furthermore advantageous that the first layer is made out of polyethylene terephthalate PET plastic.

It is advantageous that the outer envelope is made of aluminum.

It is further advantageous that the material mixture is disposed in a matrix.

It is also advantageous that a silicate (SiO₂) or a plastic foil is employed for the matrix.

Furthermore it is advantageous that the device for displaying the influence of the environment onto environmentally dependent materials is characterized by

a suitable material mixture, which changes its visually perceivable features, such as for example the color, under the interaction with external influences of the environment;

a matrix which encloses the material mixture, wherein the matrix exhibits a high diffusion resistance (coefficient) for predetermined gases;

a gas impermeable outer envelope.

It is advantageous here that the polyethylene terephthalate PET plastic layer (matrix) has the thickness of between 10-500 micrometers.

It is the also advantageous that the average particle diameter of the material mixture is disposed between 10-300 micrometers.

It is therewith further advantageous that the material mixture exhibits a chemical luminescence indicator for displaying the interaction of the environment with the material mixture.

Here it is further advantageous to obtain by extraction of the certain component of the desired composition in the melt liquid material of the residual components by the following method, wherein the desired composition is defined as the sum of the certain component in the desired composition and of the residual components and wherein the certain component of the desired composition can comprise several individual components. For this purpose the following process steps are required:

1. Furnishing the certain component of the desired composition and of the residual components as a mixture; and
2. Melting of the main amount of the mixture and thereby reducing the viscosity of the melt liquid mixture; and
3. Forming of a gradient of a certain component in the mixture by operation of forces, which are caused by fields from the outside on the certain component, thereby a certain motion of the certain component is effected in a predetermined direction within the mixture; and
4. Cooling of the mixture to room temperature and therewith solidification of the melt liquid mixture to the desired composition, which composition is composed out of the certain component and the residual components, wherein the concentration of the certain component exhibits a gradient inside of the material.

According to a preferred embodiment of the present invention the forces comprise gravitation forces.

According to another preferred embodiment of the present invention the forces comprise centrifugal forces.

According to an alternative embodiment of the present invention the forces comprise electrical and/or magnetic forces, wherein in this case the certain component can be pre-treated for exerting an influence on the certain component by electrical and/or magnetic forces. This pretreatment can for example comprise the coating or, respectively, application of materials onto the certain component, wherein electrical and/or magnetic forces exert an influence on the materials.

According to a preferred embodiment of the present invention the residual components can comprise clear transparent plastics.

According to a preferred embodiment of the present invention the residual components can be PC (polycarbonate), PET (polyethylene terephthalate), PA (Polyacrylate), PVC (polyvinyl chloride) and/or PVDC (polyvinylidene chloride).

According to a preferred embodiment of the present invention the certain component can comprise a dye and/or softener.

According to a preferred embodiment of the present invention the certain component can comprise an indicator, in particular an indicator for oxygen, and/or an indicator for reaction products of a compound of the certain component.

According to a preferred embodiment of the present invention the certain component can comprise an oxidizable powder.

According to a preferred embodiment of the present invention the certain component can comprise TiClₓ, wherein x is a number from between 3 and 4.

According to a preferred embodiment of the present invention the decrease of viscosity can be furnished by heating with infrared IR-radiation, microwave radiation, laser irradiation and/or simple thermal radiation or, respectively, convection (for example with a hair dryer or oven).

According to a preferred embodiment of the present invention the layer of the desired composition can exhibits a thickness of from about 100 to 400 micrometers.

According to a preferred embodiment of the present Invention the particles of the certain component can exhibits an average diameter of from about 30 to 100 micrometers.

The gradient of the melt liquid extraction of the certain component can be determined through the time of the melt liquid extraction in all embodiments. Both the certain component as well as the composition of the residual components can be treated for improving the wetting properties. For this purpose the certain component can be such pre-treated or coated (for example siliconized), that the wetting of the certain component is improved with the composition of the residual components. Also the composition of the residual components can be pre-treated (for example with plasma), in order to improve in this manner the wetting properties for the certain component.

The invention is the explained in more detail by way of drawings into sections now following. There is shown in

FIG. 1 the schematic construction of the invention device (1);

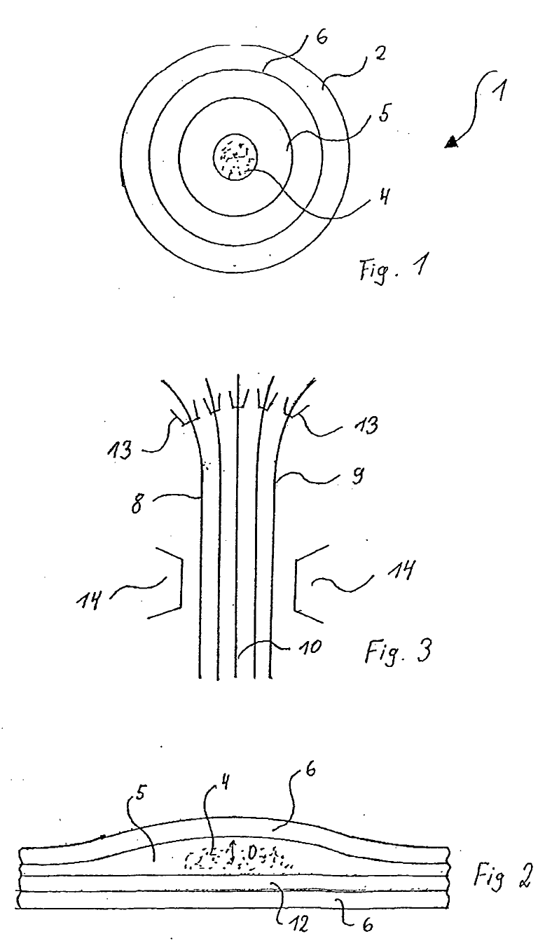

FIG. 2 a schematic representation of an embodiment example of the device (1) according to the present invention;

FIG. 3 a schematic representation of the process for production of product (10) with a steady gradient cross to the surface (11) of the product (10);

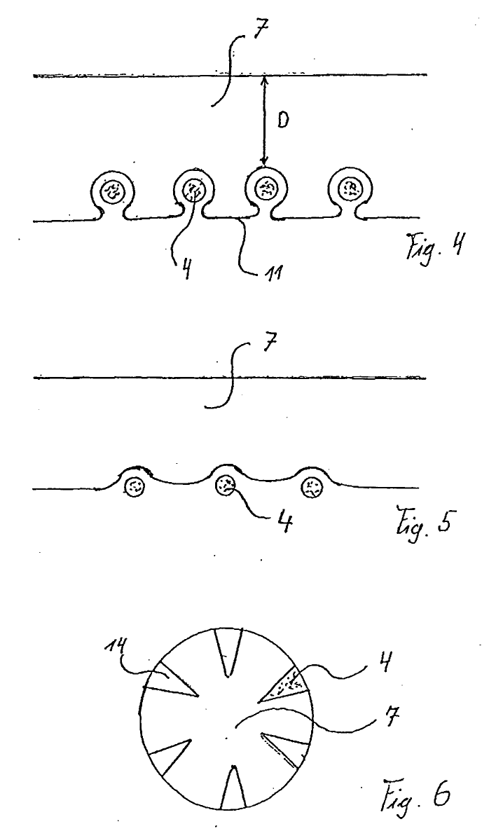

FIG. 4 a schematic cross section through a foil (7), wherein material mixtures (4) according to the present invention are enclosed at one surface (11) of the foil;

FIG. 5 a schematic cross section through a foil (7), wherein material mixtures (4) according to the present invention are impressed as one surface (11) of the foil;

FIG. 6 a schematic representation of a granulate of a matrix (7′), wherein the material mixture (4) is attached on the matrix (7′).

The FIG. 1 shows in the schematic construction of the device 1 according to the present invention. The core of the device 1 is the material mixture 4, wherein a first layer 5 or, respectively, a matrix is laid around the material mixture 4. The first layer 5 (matrix) is a polyethylene terephthalate PET-layer according to the present embodiment, wherein the diffusion resistance or, respectively, the diffusion coefficient of the PET-layer is high for gases, such that it will take a relatively long time for surrounding gases, for example oxygen, until they enter into contact with the material mixture 4. The environment 2 of the device 1 is the air in a standard situation wherein the main components of the air are nitrogen and oxygen. A gas impermeable wrapper 6 is laid around the first layer 5 such that the surrounding gas comes into touch with the first layer 5 only if the wrapper 6 has been removed. The wrapper 6 comprises a thin aluminum foil in the simplest case.

FIG. 2 shows a schematic representation of an embodiment of the device 1 according to the present invention. A self adhesive layer 12 is applied onto at least one side of the thin aluminum foil 6, wherein the self adhesive layer 12 on the one hand receives and retains the material mixture 4 or, respectively, the matrix (7,7′) The matrix 7 or, respectively, 7′ in one case can be a prepared foil plastic-foil or a carrier 7′ built on a silicon base, which will be described in detail further down. The particle, which the material mixture 4 comprises, exhibits a variable diameter disposed between 10-300 micrometers. Practically, the particles form the material mixture 4 and can be placed also without carrier onto the adhesive layer 12, for example by coating, evaporation or fogging on. A first layer 5 made out of the polyethylene terephthalate PET-foil is disposed above the material mixture 4 or, respectively, the matrix into which the material mixture 4 is incorporated, wherein the thickness (D) of the PET-foil determines the diffusion time (tD) of the surrounding gases or, respectively, the environment 2. The time for the reaction of the gases with the material mixture 4 can be adjusted therefore with the thickness (D) of the first layer 5 of the matrix. The thickness of the first layer 5 in general moves between 30-500 micrometers. The first layer 5 is held on the aluminum layer 6 by way of the self adhesive layer 12. Aluminum exhibits amongst others the property to be practically sealingly tight against oxygen such that no oxygen can penetrate to the first layer 5 until this layer 6 of aluminum has been removed.

The FIG. 3 shows a schematic representation of the method for producing of a product 10 with a steady gradient cross to the surface 11 of the product 10, wherein a first embodiment of the matrix 5 is produced from the product 10. The melt liquid granulate, which contains the material mixture 4 is extruded from at least two nozzles 13,13′ to at least two foils, wherein the at least two foils are led together in the device 14 not described in detail here and are molten with each other together. Because of the different component concentration (C) of the individual strands 8,9, a gradient of the components of the material mixture 4 forms in the foil final product 10, wherein the size of the gradient can be precisely controlled. The steadiness of the gradient arises based on the melting together of the boundary layer of the individual strands 8,9.

The FIG. 4 shows a schematic cross section through a foil 7, wherein material mixtures 4 according to the present invention are enclosed at one surface 11 of the foil 7. The enclosure of the material mixtures 4 can be produced in the most different kind and way with the aid of fields (F). The fields can be electrical fields, magnetic fields or force fields. The material mixture 4 comprises amongst others TiCl₃, which was prepared as follows:

Based on the sensitivity of TiClₓ to oxygen, the following examples were performed by applying the Schlenk-technique and under employment of nitrogen.

### EXAMPLE 1

A powder of TiClₓ (for example TiCl₃) with an average particle diameter of about 30 micrometers was siliconized in order to furnish a better wetting by polyvinyl chloride PVC. Thereupon a mixture of these pretreated particles with clear view-PVC polyvinyl chloride (without softener) was produced and this mixture was melted by heat (infrared IR-radiation). The mixture was now spread to a layer and was subjected to a centrifugation while the temperature remained the same, wherein the heavy pretreated TiClₓ formed a gradient in a certain direction within the composition of the layer.

### EXAMPLE 2

Example 1 was repeated with the exception that the pre-treatment of the TiClₓ additionally included the entering of magnetic material into the TiClₓ-particles and that the furnishing of the gradient was not accomplished by centrifugation but instead through application of a magnetic field. This means in other words that small magnetic particles are incorporated into the granulate, wherein a magnetic and/or electric field acts on the granulate in its totality.

### EXAMPLES 3 AND 4

The examples 1 and 2 were repeated with the exception that instead of poly-vinyl chloride PVC a polyvinylidene chloride PVDC was employed.

### EXAMPLES 5 AND 6

The examples 1 and 2 were repeated with the exception that instead of polyvinyl chloride PVC a polyacrylate PA 6.6 was employed.

### EXAMPLES 7 AND 8

The examples 1 and 2 were repeated with the exception that instead of polyvinyl chloride PVC a polyethylene terephthalate PET was employed.

### Results

Compositions were determined in the context of the evaluation of the preceding examples, which comprised PVC or, respectively, PVDC or, respectively, PA 6.6 or, respectively, PET and (TiClₓ) TiCl₃, wherein the concentration of (TiClₓ) TiCl₃ exhibited a gradient from low concentration to high concentration in the desired composition and wherein this gradient a low concentration on one side of the composition (concentration equal to 0) and a high concentration on the other side of the composition furnished (a concentration of about 30 weight percent). These compositions were employed in display devices for displaying the approximate service live according to German printed Patent document 10 2005 010 224.7 and were there exceptionally well suited for displaying the time dependent influence of oxygen. According to further experiments, different gradients of (TiClₓ) TiCl₃ were constructed in the composition, wherein thereby different times became possible for the interaction of the oxygen with the indicator and thus different display time periods became possible.

FIG. 5 shows a schematic cross section through a foil 7 wherein material mixtures 4 according to the present invention were pressed in at one surface 11 of the foil 7 by mechanical force interaction, this means the material mixtures 4 were rolled in. The material mixture for was here finely distributed and placed on the one surface 11 of the plastic foil 7 and pressed in into following, such that the gradient of the component concentration (C) was adjusted from the one side to the other side of the foils 7.

The FIG. 6 shows a schematic representation of a granulate of a matrix 7′, wherein the material mixture 4 adheres to the matrix 7′. The granulate or, respectively, the matrix 7′ exhibits pores 15, wherein the material mixture 4 with at least one acid indicator can become fixed in the pores 15. The granulate can have electromagnetic properties in order to increase the effectiveness of the fields (F). The main component of this granulate 7′ is built on a silicon basis.

1.-36. (canceled)

37. A method for production of a device (1) for displaying the interaction of the environment (2) onto an environmentally dependent material (3) comprising the following process steps:
employing a suitable materials mixture (4) including a chemo luminescence indicator or TiCl₃;
furnishing the suitable material mixture (4) under addition of at least one component, which component changes its visual perceivable features under reaction with outer influences of the environment (2);
coating and enveloping the suitable material mixture (4) in a matrix (7,7′) with a high diffusion resistance (coefficient) for predetermined gases,
producing a first layer (5) out of a polyethylene terephthalate; and
producing an outer gas impermeable envelope (6).

38. The method according to claim 37 further comprising
disposing the material mixture (4) in the matrix (7,7′).

39. The method according to claim 37 further comprising
employing a silicate (SiO2) or a plastic foil for the matrix (7,7′).

40. The method according to claim 37 further comprising
employing a poly carbonate, a polyethylene terephthalate, poly acrylic acid, polyvinyl chloride or poly vinylidene chloride for the matrix (7,7′).

41. The method according to claim 37 further comprising
employing an indicator or an indicator for reaction products of a chemical compound of the at least one component of the suitable materials mixture (4) as the at least one component of the suitable materials mixture (4).

42. The method according to claim 37 further comprising
employing an oxydizable powder as the at least one component of the suitable materials mixture (4).

43. The method according to claim 37 further comprising
employing silicone and TiClx as a part of the at least one component of the suitable materials mixture (4), wherein the at least one component exhibits a medium particle size of about 30 micrometers and wherein a layer of the suitable materials mixture (4) exhibits a thickness of from about 20 to 400 micrometers, wherein x is a number between 3 and 4.

44. A device for displaying the interaction of the environment (2) onto an environmentally dependent material (3) comprising
a suitable materials mixture (4) including a chemo luminescence indicator or TiCl3;
and wherein the suitable material mixture (4) under addition of at least one component, which component changes its visually perceivable features under reaction with outer influences of the environment (2);
a matrix (5, 7, 7′) with a high diffusion resistance (coefficient) for predetermined gases and enclosing the suitable materials mixture (4); and
an outer gas impermeable envelope (6) made out of aluminum and surrounding the matrix (5, 7, 7′).

45. The device according to claim 44 wherein a polyethylene terephthalate PET-plastic layer (5) is between 10 and 500 micrometer thick and is part of the matrix (5, 7, 7′).

46. The device according to claim 44 wherein an average particle diameter of the material mixture (4) is disposed between 10 and 300 micrometers.

47. A method for production of component concentrations (C) of a suitable materials mixture (4) in a material, preferably a material for production of plastic foils, characterized by the following process steps:
furnishing of a suitable material mixture (4) under addition of at least one component;
changing visually perceivable features of one component under reaction of outer influences of the environment (2);
effecting the component concentration (C) of the suitable materials mixture (4), including a chemo luminescence indicator or TiCl₃, by application of a field (F).

48. The method according to claim 47 further comprising:
furnishing of a certain component in the suitable material mixture (4);
melting of the suitable material mixture (4);
forming of a gradient of the predetermined component concentration (C) of the suitable material mixture (4) in the melt liquid mixture by reacting of forces through at least one field (F) outside of the suitable material mixture (4) in a predetermined direction within the melt liquid mixture;
cooling off the melt liquid mixture to room temperature and thereby solidifying of the melt liquid material mixture (4) with a predetermined gradient within the matrix (7,7′).

49. The method according to claim 48 wherein the forces comprise
gravitational forces or centrifugal forces or Coulomb forces.

50. The method according to claim 47, wherein the fields (F) are of an electrical and/or magnetic nature or gravitational, wherein the suitable material mixture (4) can be pretreated in order to improve the force effect of the fields (F).

51. The method according to claim 47 further comprising generating a viscosity decrease by heating with infrared IR-radiation, microwave radiation, laser radiation and/or simple thermal radiation or, respectively, thermal convection.

52. The method according to claim 47 further comprising
producing foils are produced both in blowing technique as well as also in rolling technique.

53. The method according to claim 47 further comprising
applying a material mixture (4) of a predetermined component concentration (C) to the surface (10) of a plastic foil (7); and
pressing in the following the suitable material mixture (4) into the plastic foil (7) by force interaction (F).

54. The method according to claim 47 further comprising
impacting the surface (10) of a plastic foil (7) with an agent which softens the surface of the plastic foil (7); and
penetrating with the suitable material mixture (4) into the plastic foil (7) by the effect of force (F).

55. The method according to claim 47 further comprising
adjusting the time dependence of the change of the feature by selecting of the components accordingly.
